(19) United States
(12) Patent Application Publication
(10) Pub. No.: US 2012/0282986 A1
(43) Pub. Date: Nov. 8, 2012

(54) System and Method for Providing Dynamic Insurance Policy Claim and Contest Entry Claim Resolution Infrastructure for Automatically Identifying and Settling Valid Insurance Claims in connection with Previously Acquired Competitive Prize-Bearing Game Event-Related Insurance Policies, and for Automatically Identifying and Resolving Valid Claims in connection with Prize-Bearing Contests

(75) Inventor: Eugene Castro, Henderson, NV (US)

(73) Assignee: BBL ENTERPRISES, LLC, Las Vegas, NV (US)

(21) Appl. No.: 13/463,782

(22) Filed: May 3, 2012

Related U.S. Application Data
(60) Provisional application No. 61/482,186, filed on May 3, 2011.

(51) Int. Cl. A63F 13/00

(52) U.S. Cl. 463/1

(57) ABSTRACT

The present invention provides a modular and flexible system and method, readily usable in conjunction with various game-event-related insurance policy provision solutions, for selectively and/or automatically identifying and settling eligible claims associated with corresponding previously acquired game-event-related insurance policies, either in a manner transparent to the policyholder, or automatically, but under selective control thereof.

### CROSS REFERENCE TO RELATED APPLICATIONS

The present patent application claims priority from, the commonly assigned co-pending U.S. Provisional Patent Application Ser. No. 61/482,186, entitled “System and Method for Providing Dynamic Insurance Policy Claim Resolution Infrastructure for Automatically Identifying and Settling Valid Insurance Claims in connection with Previously Acquired Competitive Wagering Game Event-Related Insurance Policies, following Availability of Game Event Results”, filed May 3, 2011.

### FIELD OF THE INVENTION

The present invention relates generally to competitive wagering game events that require at least one stake or fee as a prerequisite for player entry therein, and that conclude with a game event outcome record, at least in part comprising a ranked list of game participants (e.g., players) representative of the players' performance relative to one another, in which a predefined number of highest ranked players are eligible to receive corresponding prizes, and more particularly relates to a modular and flexible system and method for selectively and/or automatically identifying and settling eligible claims associated with corresponding previously acquired game-event-related insurance policies, that may be readily utilized in conjunction with virtually any game-event-related insurance platform.

### BACKGROUND OF THE INVENTION

Virtually all competitive prize-bearing ranked outcome game events (such as poker and other wagering game tournaments, as well as in most online tournament-based Internet based competitive games), have the following key characteristics:
(1) they require game participants to take game entry-related risk (for example by payment of an event entry fee, such as a “buy-in” in poker tournaments); and
(2) at the conclusion of the game event, the performance of all game participants is ranked relative to one another, and corresponding event prizes are provided only to participants in a predetermined number of highest ranked positions (“winning positions”), with game participants in the remaining lower ranked positions (“losing positions”) suffering losses of at least their game event entry fees, which in many cases can be quite substantial.

Not surprisingly, game participants in losing positions that are ranked closest to the lowest ranked winning position, often experience a great deal of frustration in coming relatively close to some victory, but nonetheless having to walk away from a game event with empty hands. Furthermore, in larger events, players in such “almost good enough to win” event outcome positions may have performed relatively well in the event, which further adds to their frustration at a “close loss”. For many players, repeated placements over time in such “close loss” losing positions, lead to disenchantment and loss of interest in competitive stake-based game events, resulting in decreased game event participation.

As a result, attempts have been made to provide solutions to enable game participants, in losing positions that are proximal to the lowest ranked winning position, to recover at least a portion of their stake in the game event (such as their entry fee or buy-in). One set of approaches, that achieved at least some success in the field of poker tournaments (and especially online tournaments), involves the offering of special stake-related insurance policies to tournament participants that pay out only when a policy holder finishes the tournament within a certain amount of rank positions below the lowest ranked “winning” or pay-out position (also referred to as finishing “on the bubble”).

Such solutions, often referred to as “Bubble Insurance”, are offered in different variations both by game event operations, as well as by separate companies working therewith, and typically comprise many variations in their parameters and terms and conditions. For example, one previously known bubble insurance provider offers bubble policies for an insurance fee that is determined as a percentage of the buy-in/rake fee, where the number of the event outcome positions within the “bubble” that are covered by the policy are determined on a sliding scale as a portion of the total number of tournament participants (“field size”), and where the bubble policies pay out 150% of the policyholder's non-rake portion of the buy-in fee only if a policyholder finishes the game event in one of the predefined bubble positions.

Other proposed solutions, such as disclosed in the U.S. patent application Ser. No. 12/410,690 to Nardizzi et al., offer variations on the above, such as integrating the bubble insurance policy acquisition process into the flow of a poker tournament and providing a two-tier bubble policy where the players have the option of paying an additional policy fee to be eligible to get a policy payout if they finish at a rank that is outside, but close to, the conventional range of bubble position ranks—a form of a secondary bubble.

However, all previously known bubble insurance solutions suffer from a number of significant disadvantages and drawbacks that have prevented them from gaining more than a marginal level of acceptance/popularity:
(a) there is no standardization of any kind between various bubble insurance offerings, and with each provider having a myriad set of rules, policy parameters, as well as restrictions that limit their use to only certain specific types of tournament game events (or to events from predefined event operators only), players wishing to purchase bubble insurance in connection with different game events need to subject themselves to multiple different time consuming policy acquisition processes, familiarize themselves with, and track different sets of policy rules, terms and conditions for policies purchased for each corresponding game event—a complex and time-consuming endeavor unnecessarily distracting players from gameplay;
(b) in view of (a) above, unless bubble insurance is offered and provided as an integral in-house aspect of a particular poker tournament (which carries a number of legal and other complications), many players simply don't even think about (or forget the existence of) bubble insurance offerings, essentially neglecting them;
(c) because most non-in-house bubble policies comprise strict timed claim rules, policyholders must remember to check their claim eligibility after conclusion of each event for which they hold a policy, and then to formulate and submit each claim for processing within a relatively short period of time (typically within 48 hours of an event conclusion), where if they miss this deadline or if they submit their claim with any errors, the policy claim will be denied. Clearly, this arrangement places additional burdens on game participants and can lead to further frustration when otherwise eligible claims are unpaid due to a missed claim deadline or an error in a submitted claim settlement request; and
(d) the tight-knit integration of the current bubble insurance offerings with various poker tournaments, limits their utilization only in connection therewith, precluding their utilization with non-poker competitive stake-based prize-bearing game events, such as online video game tournaments, sports tournaments, “casual games” competitive events for online games utilizing virtual currencies, etc.

Advantageously, various embodiments of a novel system and method for comprehensively resolving virtually all of the above-described challenges and issues are taught and described in the commonly assigned co-pending U.S. patent application entitled “SYSTEM AND METHOD FOR PROVIDING CONFIGURABLE PLAYER STAKE-RELATED INSURANCE FOR PREDETERMINED RANGE OF PAYOUT POSITIONS IN COMPETITIVE WAGERING GAMES, HAVING AUTOMATED POLICY ACQUISITION AND CLAIM RESOLUTION FUNCTIONS”, application Ser. No. 13/463,773 (hereinafter, the “'773 Application”), that is hereby incorporated herein in its entirety. Additional beneficial solutions to the above-noted challenges and issues have also been provided in the commonly assigned co-pending U.S. patent application entitled “SYSTEM AND METHOD FOR PROVIDING CONFIGURABLE AUTOMATED INSURANCE POLICY ACQUISITION INFRASTRUCTURE FOR SELECTIVE ACQUISITION OF INSURANCE PRODUCTS RELATED TO COMPETITIVE PRIZE-BEARING GAMES”, application Ser. No. 13/463,779 (hereinafter, the “'779 Application”), that is hereby incorporated herein in its entirety

However, while the '773 Application offered various flexible comprehensive solutions comprising a range of modular components from insurance policy formulation, to automatic claim settlement, and while the '779 Application provided user-centric flexible and modular infrastructure for dynamically offering various pre-configurable and easy to acquire insurance policies for reducing financial risks associated with entry into, and participation in, various competitive game events, it would be desirable to provide a modular and flexible system and method for selectively and/or automatically indentifying and settling eligible claims associated with corresponding previously acquired game-event-related insurance policies, that may be readily utilized in conjunction with virtually any game-event-related insurance platform.

### BRIEF DESCRIPTION OF THE DRAWINGS

In the drawings, wherein like reference characters denote corresponding or similar elements throughout the various figures:

FIG. 1A is an exemplary schematic diagram illustrating a first exemplary embodiment of a process flow representative of the basic operation of an inventive system for automatically identifying and settling eligible insurance policy claims for policyholders of competitive game-event-related insurance policies following the conclusion of the corresponding game events;

FIG. 1B is an exemplary schematic diagram illustrating a second exemplary embodiment of a process flow representative of the basic operation of an inventive system for automatically identifying and settling eligible insurance policy claims for policyholders of competitive game-event-related insurance policies following the conclusion of the corresponding game events; and

FIG. 2 is an exemplary schematic block diagram illustrating an exemplary embodiment of the inventive system for performing various steps set forth in the inventive process flows of FIGS. 1A and 1B.

### SUMMARY OF THE INVENTION

The present invention provides a modular and flexible system and method, readily usable in conjunction with various game-event-related insurance policy provision solutions, for selectively and/or automatically indentifying and settling eligible claims associated with corresponding previously acquired game-event-related insurance policies, either in a manner transparent to the policyholder, or automatically, but under selective control thereof.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The system and method of the present invention addresses the flaws and disadvantages of previously known “bubble insurance”-related solutions, and, in particular, the burden placed on the policyholder, by most previously known game-event-related solutions, of manually identifying policy claim eligibility, and subsequent non-flexible claim settlements, by providing various advantageous embodiments of a modular and flexible system and method for selectively and/or automatically indentifying and settling eligible claims associated with corresponding previously acquired game-event-related insurance policies (i.e., when predefined coverage conditions for such policies are met), that may be readily utilized in conjunction with virtually any game-event-related insurance platform.

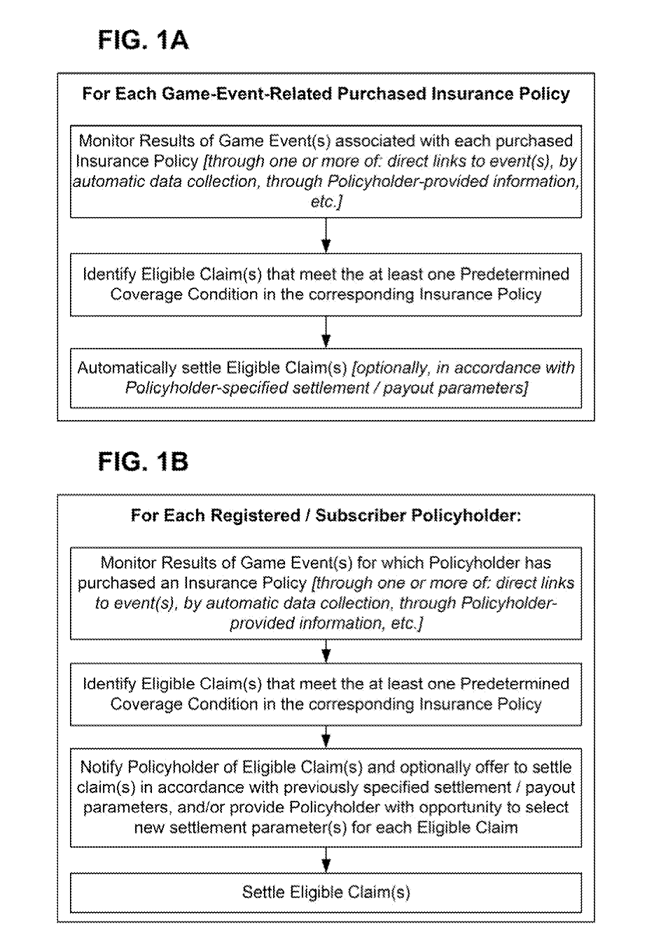

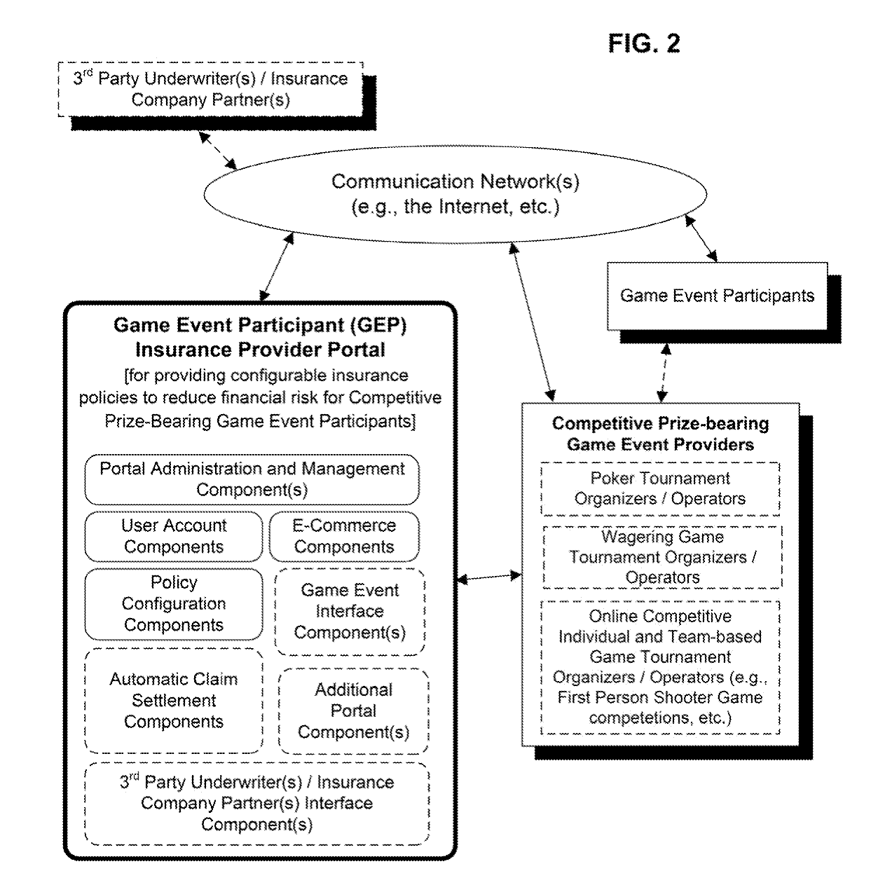

Referring now to FIG. 1A, in a first exemplary embodiment thereof, the inventive system and method comprise the following features, by way of example:
Dynamically identifying and settling eligible insurance policy claims for previously purchased game-event-related insurance policies, each having a predetermined coverage condition, through:
   (a) monitoring results of at least one game event associated with each previously purchased insurance policy (through one or more of: direct links to event(s), by automatic data collection, through policyholder-provided information, etc.);
   (b) identifying at least one eligible claim that meets at least one predetermined coverage condition in a corresponding insurance policy; and
   (c) automatically settling the at least one identified eligible claim (optionally, in accordance with policyholder-specified settlement/payout parameters).

Referring now to FIG. 1B, in a second exemplary embodiment thereof, the inventive system and method comprise the following features, by way of example:
Dynamically identifying and settling eligible insurance policy claims for game-event-related insurance policies, each having a predetermined coverage condition, that have been previously purchased by a predetermined policyholder, through:
   (a) monitoring (through one or more of: direct links to event(s), by automatic data collection, through Policyholder-provided information, etc.), the results of each game event for which the predetermined policyholder has purchased an associated insurance policy;
   (b) identifying at least one eligible claim that meets the at least one predetermined coverage condition in a corresponding insurance policy;
   (c) notifying the predetermined policyholder of each identified eligible claim;
   (d) enabling the predetermined policyholder to selectively determine the settlement of each eligible claim in accordance with at least one of: at least one previously configured claim settlement parameter, and one or more newly selected settlement parameter; and
   (e) automatically settling said at least one identified eligible claim in accordance with the at least one above-determined settlement parameter.

In accordance with the present invention, the various embodiments of the above-described modular system and method are preferably configurable for compatibility with any number of approaches/techniques/solutions for offering and providing various game-event-related insurance policies, whether through currently available/conventional means, or such as disclosed in the '185 Application, as a matter of design choice or convenience, without departing from the spirit of the invention.

Advantageously, various embodiments of the present invention may be utilized as stand-alone modules integrated with any event administration/operation systems utilized by any online competitive prize-bearing game event providers.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the present invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

I claim:

1. A data processing method for dynamically identifying and settling eligible insurance policy claims for previously purchased game-event-related insurance policies, each having a predetermined coverage condition, comprising the steps of:
(a) monitoring results of at least one game event associated with each previously purchased insurance policy;
(b) identifying at least one eligible claim that meets the at least one predetermined coverage condition in a corresponding insurance policy; and
(c) automatically settling said at least one identified eligible claim.

2. A data processing method for dynamically identifying and settling eligible insurance policy claims for game-event-related insurance policies, each having a predetermined coverage condition, that have been previously purchased by a predetermined policyholder, comprising the steps of:
(a) monitoring results of each game event for which the predetermined policyholder has purchased an associated insurance policy;
(b) identifying at least one eligible claim that meets the at least one predetermined coverage condition in a corresponding insurance policy;
(c) notifying the predetermined policyholder of each identified eligible claim;
(d) enabling the predetermined policyholder to selectively determine the settlement of each eligible claim in accordance with at least one of: at least one previously configured claim settlement parameter, and one or more newly selected settlement parameter; and
(e) automatically settling said at least one identified eligible claim in accordance with at least one settlement parameter determined at said step (d).
